(19) United States
(12) Patent Application Publication
(10) Pub. No.: US 2007/0106803 A1
(43) Pub. Date: May 10, 2007

(54) WEB SITE SUBSCRIPTION MANAGEMENT SYSTEM

(75) Inventors: James B. Peterson, Boston, MA (US); David M. Chan, Cambridge, MA (US); Jeffrey S. Mancuso, Cambridge, MA (US)

Correspondence Address: JACOBS & KIM LLP, 1050 WINTER STREET, SUITE 1000, #1082, WALTHAM, MA, 02451-1401, US

(73) Assignee: PIXELPASS LLC, Waltham, MA (US)

(21) Appl. No.: 11/163,993

(22) Filed: Nov. 7, 2005

(51) Int. Cl. G06F 15/16

(52) U.S. Cl. 709/229

(57) ABSTRACT

In a method for managing subscriptions to a web site, a determination is made as to whether an end user accessing a web page at the web site is a current subscriber to the web site. If it is determined that the end user does not have a current subscription, an obscuring layer is placed over the web page that at least partially obscures at least a portion of thereof. The obscuring layer includes a link to a subscription server for purchasing a subscription to the web site. If it is determined that the end user is a current subscriber, the end user is provided with non-obscured access to the web site. In a further method for managing subscriptions to a web site, when an end user accesses a web page at the web site, a remote subscription server is accessed. The end user's computer automatically sends to the remote subscription server an end user identification and a merchant identification. A determination is made as to whether the end user has a current subscription to the web site. If it is determined that the end user does not have a current subscription to the web site, the remote server sends to the end user an obscuring layer that at least partially obscures at least a portion of the web page.

### REFERENCE TO COMPUTER PROGRAM APPENDIX

Submitted herewith in the form of an electronic text file is a computer program appendix, p.xhtml.txt, which is incorporated herein in its entirety.

### BACKGROUND OF THE INVENTION

1. Field of the Invention

The present invention relates to improvements in the field of internet commerce, and more specifically to improved systems and methods for managing subscriptions to web sites.

2. Description of Prior Art

Developing a successful web site subscription program can be a challenge, particularly for lesser known web sites, and web sites having limited resources. One issue commonly faced by web site managers is how best to encourage customers to purchase subscriptions. A typical approach used by well-established, high-end web sites is to provide a small portion of content for free. For example, a news web site may provide, for free, titles and brief excerpts from articles that are available on the web site. In order to gain full access to the articles, an end user must typically either purchase a subscription to the web site, or make a one-time payment to view an individual article.

However, this approach is not suitable for all web sites. For example, if a web site is not well known, an end user may be hesitant to purchase a subscription based only on a review of article titles and excerpts. Further, a small web site may not have the know-how, man-hours, and other resources necessary to maintain an effective subscription program of this type.

Thus, many web sites provide all of their content for free. Some of these web sites may also include requests for voluntary contributions. Needless to say, this approach provides little, if any, inducement for end users to send money to a given web site. At least some of these free web sites have the potential of generating significant subscription income from their provided content, particularly if there were a way to introduce a subscription program with a minimum investment of time and money.

### SUMMARY OF THE INVENTION

These and other issues are addressed by aspects of the present invention. A first aspect of the invention provides a method for managing subscriptions to a web site. A determination is made as to whether an end user accessing a web page at the web site is a current subscriber to the web site. If it is determined that the end user does not have a current subscription, an obscuring layer is placed over the web page that at least partially obscures at least a portion of thereof. The obscuring layer includes a link to a subscription server for purchasing a subscription to the web site. If it is determined that the end user is a current subscriber, the end user is provided with non-obscured access to the web site.

A further aspect of the invention provides a method for using a remote subscription server to manage subscriptions to a merchant's web site. When an end user accesses a web page at the web site, a remote subscription server is accessed. The end user's computer automatically sends to the remote subscription server an end user identification and a merchant identification. A determination is made as to whether the end user has a current subscription to the web site. If it is determined that the end user does not have a current subscription to the web site, the remote server sends to the end user an obscuring layer that at least partially obscures at least a portion of the web page.

Additional features and advantages of the present invention will become apparent by reference to the following detailed description and accompanying drawings.

### BRIEF DESCRIPTION OF THE DRAWINGS

FIG. 1 shows a screenshot of a demonstration web page according to a first aspect of the invention.

FIG. 2 shows a screenshot of the web page shown in FIG. 1, to which an obscuring layer has been added.

FIG. 3 shows a screenshot of the web page shown in FIG. 2, including a popup window that is accessed when an end user clicks on the obscuring layer.

FIGS. 4-6 show a series of screenshots illustrating further screens that are accessible from through the popup window shown in FIG. 3.

FIG. 7 shows a flowchart of a method according to a further aspect of the invention, in which an obscuring layer is used as part of a subscription program.

FIGS. 8 and 9 show diagrams illustrating the flow of data in a technique according to a further aspect of the invention, in which a remote server is used to administer a subscription program.

FIG. 10 shows a flowchart of a method embodying the flow of data illustrated in FIGS. 8 and 9.

### DETAILED DESCRIPTION

As described hereinbelow, the present invention provides systems and methods for managing subscriptions to a web site. A first aspect of the invention provides a technique for using an obscuring layer to encourage an end user to purchase a subscription to a web site. Further aspects of the invention are directed to techniques by which a remote server may be used to manage a subscription program for a web site.

A web site typically comprises a plurality of web pages and associated files that have been created by a content provider and loaded onto a server that is accessible over the internet. Each web page is stored on the server as lines of code. Web page coding is commonly written using Hypertext Markup Language (HTML), or similar programming language.

Each web page has a unique address, known as a uniform resource locator (URL). An end user accesses a web page through a computer connected to the internet, using a software program known as a web browser. The end user accesses a web page either by typing the web page's URL into the address bar of the web browser, or by clicking on a link containing the web page's URL. The end user's computer exchanges data with the web site server. As part of this exchange of data, the coding for the web page is downloaded onto the end user's computer. The end user's web browser then converts the downloaded code into a viewable web page.

As used herein, the terms “content provider” and “merchant” are used interchangeably, and refer to a provider of content over the World Wide Web. The terms “end user” and “customer” are also used interchangeably, and refer to a person or persons accessing content over the World Wide Web.

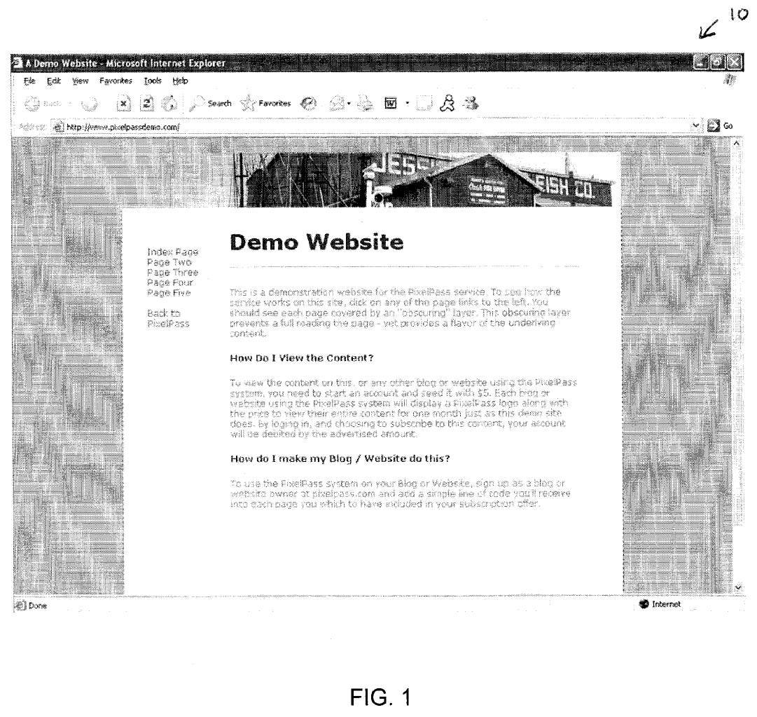

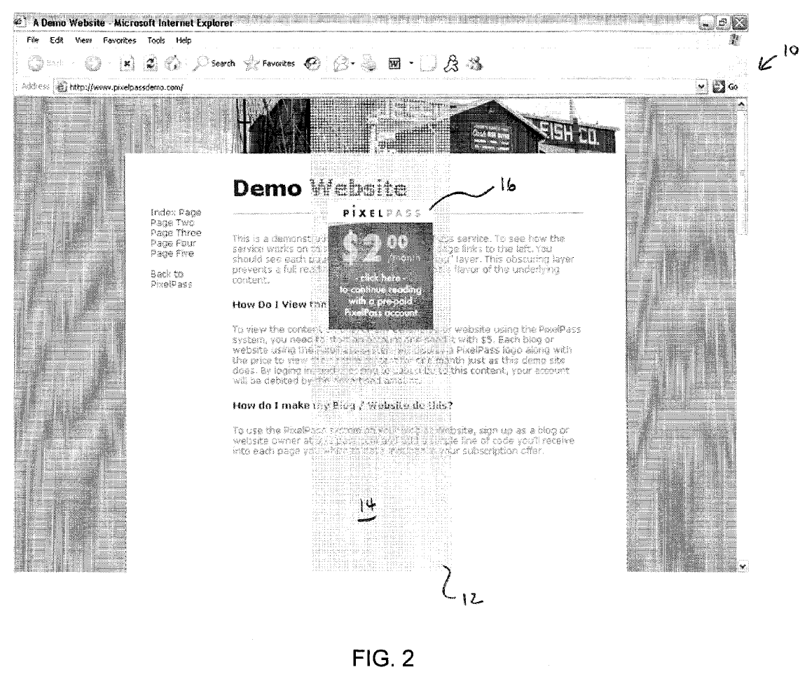

FIGS. 1 and 2 show screenshots of a web page 10 according to a first aspect of the invention. In FIGS. 1 and 2, it is assumed for the purposes of discussion that the web page 10 is part of a web site created by a merchant who is seeking subscriptions to the web site. The web page 10 is shown as it appears on an end user's computer running Internet Explorer. The invention is configured to work with all major web browsers, including Netscape Navigator, Mozilla Firefox, and the like. The scope of the present invention is not limited to a particular software environment. In particular, it will be appreciated that it would be possible to modify the invention to operate using different types of software and hardware without departing from the spirit of the invention.

In FIG. 1, the demo web page 10 is shown in its fully viewable, non-obscured form. In FIG. 2, the demo web page 10 includes an obscuring layer 12 that at least partially obscures at least a portion of the web page 10. In FIG. 2, it will be seen that the obscuring layer 12 is designed such that an end user is able to view a significant portion of a designated web page through, and around, the obscuring layer 12.

As discussed below, a merchant has flexibility in deciding which web pages on a web site are protected by an obscuring layer. Some merchants may choose protect all of a web site's pages with an obscuring layer. However, a merchant may also decide to protect only certain designated pages on a web site. In that case, end users would have complete, non-obscured access to all non-protected pages on the site, in addition to having obscured access to the protected pages.

Returning to FIG. 2, the reason that so much of the web page 10 is viewable through the obscuring layer 12 is that the primary function of the obscuring layer 12 is not to provide security, but rather to act as an inducement to an end user to purchase a subscription to the web site. Thus, as shown in FIG. 2, the obscuring layer 12 is designed to allow an end user to view enough of the content of the web site to provide the end user with a flavor for the web site, allowing the end user to make an informed decision as to whether to purchase a subscription. Before deciding to purchase a subscription, an end user may view all of a web site's pages, some of which may be protected by an obscuring layer, and some of which may not.

Because the primary function of the obscuring layer is not security, it may be possible for some end users to defeat the obscuring layer 12, in its current implementation. However, it is believed that the number of such end users would be acceptably small. In addition, it is believed that at least some of these end users would find such an effort to be more trouble than it is worth.

In FIG. 2, the obscuring layer 12 is configured as a stripe, or bar, extending vertically down the center of the web page, from top to bottom. The relative narrowness of the obscuring layer 12 allows an end user to view unobscured content at the portions of the web page beyond the left and right borders of the obscuring layer 12.

According to a further aspect of the invention, the obscuring layer 12 may be enhanced by incorporating a time component, according to which the appearance of the obscuring layer 12 changes as a function of time. For example, a time delay may be incorporated, such that when an end user accesses a protected web page, the obscuring layer 12 “fades in” after a first amount of time has expired and “fades out” after a second amount of time has expired. The obscuring layer 12 may be configured to fade in and fade out at predetermined intervals, or even at random intervals. In addition, transition effects other than fading in and fading out may be used for the appearance and disappearance of the obscuring layer 12.

In addition, the appearance of the obscuring layer 12 may be configured such that its screen position varies as a function of time. For example, the obscuring layer 12 may be configured to move across the screen, or to jump from one screen location to another. The size, shape, and color scheme of the obscuring layer 12 may also be configured to vary as a function of time. For example, the obscuring layer 12 may be configured to appear to grow or shrink, or to change from black and white to color, or vice versa. The obscuring layer 12 may also be configured to include a slideshow or animation, as desired.

It will be appreciated that any of the above described variations may be used singly or in combination with each other, or in combination with variations not specifically described above. The description of variations to the obscuring layer 12 is provided for illustration, and is not intended to be exhaustive. It will be appreciated that other variations, not specifically described above, may also incorporate the claimed features of the present invention.

As further shown in FIG. 2, the obscuring layer 12 includes a background portion 14 and a box 16. According to the present aspect of the invention, the background 14 comprises a matrix of closely spaced shapes. Web page content is viewable in the spaces between these shapes. In FIG. 2, the shapes are gray squares that are arranged into a grid pattern. The spaces between the gray squares form a lattice of intersecting horizontal and vertical lines. The overall visual effect is a blurring of the content underneath the obscuring layer 12. The clarity of the content can be adjusted by increasing or decreasing the amount of space between the shapes in the background lattice.

Box 16 is opaque, and includes a stated subscription price ($2.00 per month), and an instruction to the end user to “click here” to obtain a subscription to the web page. It should be noted that the location, shape, opacity, appearance and textual content of the background 14 and box 16 may be modified without departing from the spirit of the invention.

The obscured web page 10 shown in FIG. 2 is designed such that clicking anywhere on the obscuring layer 12 connects the user to a subscription server. According to the present aspect of the invention, the subscription server is a remote, third-party provider of services. However, it would also be possible for the subscription server to be implemented in different ways without departing from the spirit of the invention. For example, the subscription server may be part of an internal network.

It should further be noted that the obscuring layer 12 may be modified by incorporating other types of content including, for example, advertising or a branded message. Such other content may be used in conjunction with, or in place of, the other types of content described herein.

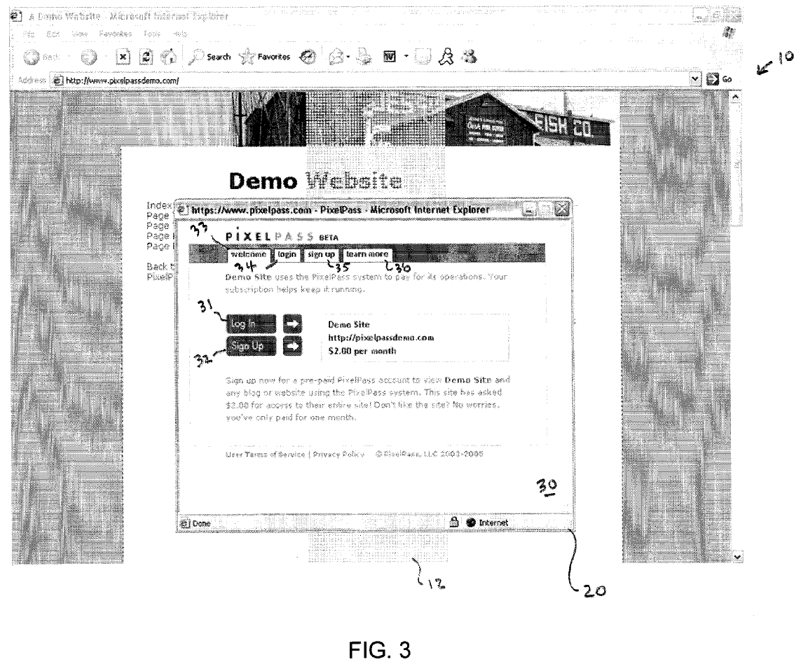

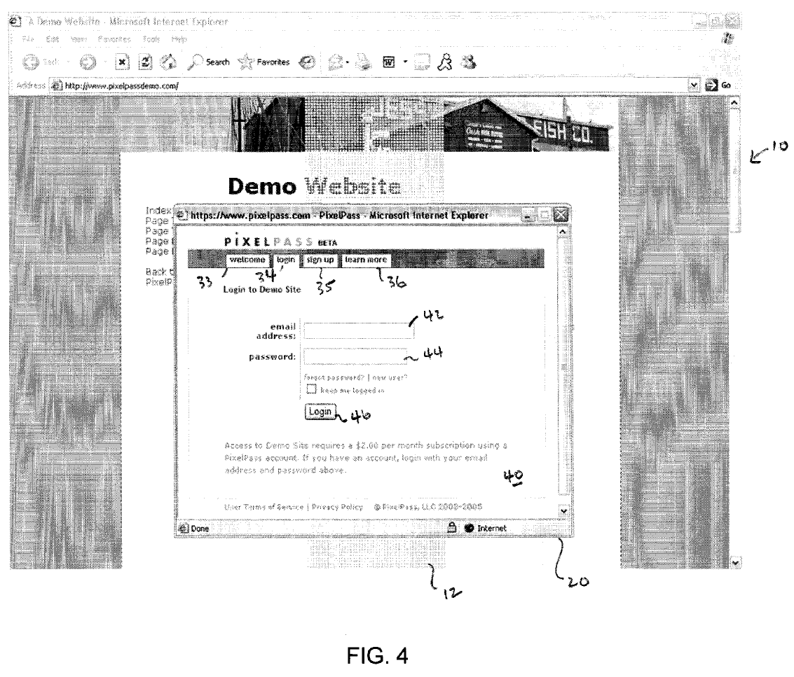

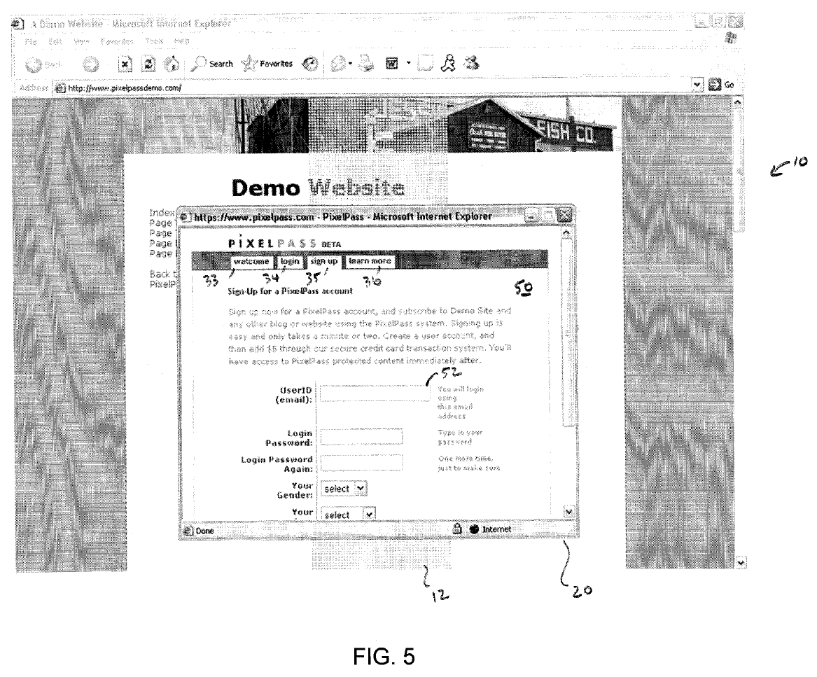

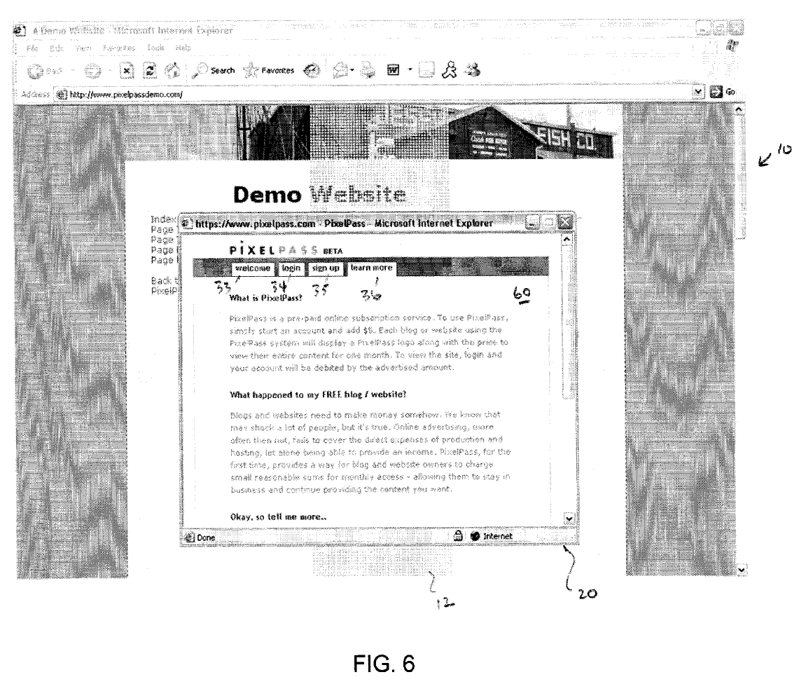

FIG. 3 shows a screenshot of the web page 10 after an end user has clicked on the obscuring layer 12. As shown in FIG. 3, a popup window 20 has appeared over the web page 10. Four screens are accessible through the popup window 20: a “welcome” screen 30, shown in FIG. 3; a “login” screen 40, shown in FIG. 4; a “signup” screen 50, shown in FIG. 5; and a “learn more” screen 60, shown in FIG. 6.

The “welcome” screen 30, shown in FIG. 3, is the screen that is initially displayed to an end user who clicks on the obscuring layer 12. In addition to providing basic information regarding the subscription service, the welcome screen 30 further includes a “log in” button 31 and a “sign up” button 32. The “log in” button 31 forwards an end user to the “login” screen 40, shown in FIG. 4. The “sign up” button 32 forwards an end user to the “signup” screen 50 shown in FIG. 5.

The top of the welcome screen 30 includes four navigation tabs: “welcome” 33, “login” 34, “signup” 35, and “learn more” 36, allowing an end user to immediately jump to each of the four screens 30, 40, 50 and 60 accessible through the popup window 20. These navigation tabs appear on all four screens.

FIG. 4 shows a screenshot of the login screen 40. The login screen 40 is used by end users who have already has signed up for an account with the subscription server. It should be noted that, according to the present aspect of the invention, establishing an account with the subscription server is different from purchasing a subscription to a particular web site having a subscription program managed by the subscription server.

The login screen 40 includes a first data entry box 42 for receiving as an input the email address used by the end user in signing up for an account with the subscription server. A second data entry box 44 is provided to receive as an input a password created by the end user as part of the signup process. After boxes 42 and 44 have been filled in, the end user clicks on the login button 46 (or hits the “enter” key) to log onto the subscription server.

As discussed below, a successful login onto the subscription server causes a unique customer identification cookie to be written to the end user's computer. This cookie is then used to identify the end user to the subscription server to confirm that the end user is logged onto the subscription server and to determine whether the end user has a current subscription to a particular web site.

If an end user successfully logs in, and if it is determined by the subscription server that the end user has a current subscription to the web page, then the web page is automatically reloaded without the obscuring layer 12. However, if it is determined that the end user does not have a current subscription to the web page, then the end user is forwarded to a screen (not shown) inviting the end user to purchase a subscription to the web page. If the end user purchases a subscription, the web page is then automatically reloaded without the obscuring layer 12. If the end user does not purchase a subscription, then the web page is reloaded with the obscuring layer 12.

The above-described process is repeated each time a subscriber visits a protected page on a web site. If a current subscriber is currently logged onto the subscription server, the process is virtually instantaneous, and is thus unnoticeable by typical end users. It should also be noted that once an end user has logged onto the subscription server, the user identification cookie that is written to the end user's computer is used for all other protected sites visited during the browsing session. Thus, an end user only has to log onto the subscription server once per session.

FIG. 5 shows a screenshot of the signup screen 50. The signup screen 50 is used by end users who have not yet established an account with the subscription server. The signup screen 50 includes a number of data entry boxes 52 for receiving inputs from the end user. After entering the requested information, the end user is directed to a payment screen (not shown), for providing payment information. Payment is made using PayPal or a major credit card. After providing payment information, the end user is then directed to a subscription screen (not shown) where the end user is asked whether he or she would like to purchase a subscription to the current web page. If the end user purchases a subscription, the designated web page is reloaded, without the obscuring layer 12. If the end user does not purchase a subscription, the designated web page is reloaded with the obscuring layer 12.

FIG. 6 shows a screenshot of the “learn more” screen 60. The “learn more” screen 60 provides general information to end users, helping them to make an informed decision as to whether to sign up for an account with the subscription server.

It should be noted that, according to the present aspect of the invention, a subscription is sold for an entire web site, rather than for individual pages on the web site. Thus, when an end user purchases a subscription, the end user gains non-obscured access to all of the pages of the web site. However, if desired, it would be possible to modify the invention to allow subscriptions to be sold to individual protected pages on a web site.

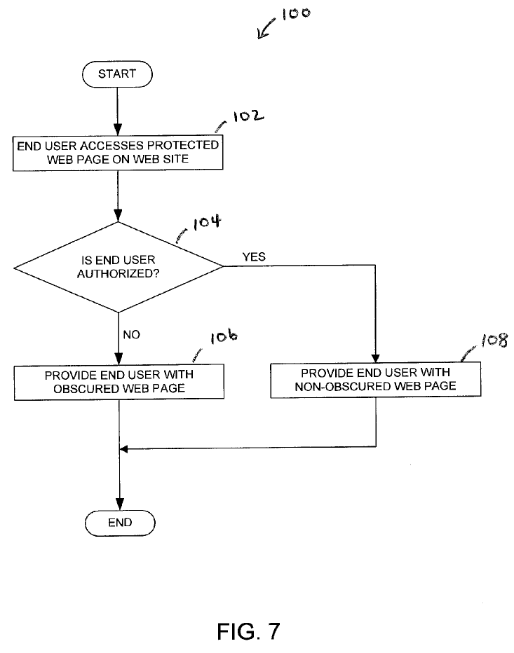

FIG. 7 shows a flowchart illustrating a method 100 according to a further aspect of the present invention for using the obscuring layer 12 and related screens shown in FIGS. 2-6 to encourage end users to subscribe to a web site. In step 102, an end user accesses a protected web page on a web site. In step 104, a determination is made as to whether the end user is authorized to view a non-obscured version of the web page. If the end user is determined not to be authorized, then in step 106 the end user is provided with a version of the protected web page containing an obscuring layer, such as the obscuring layer 12 discussed above. If the end user is determined to be authorized, then in step 108, the end user is provided with non-obscured access to the web page.

Further aspects of the invention are directed to techniques for allowing a web site's subscription program to be administered by a remote, third-party subscription server. As discussed above, subscription program functions include, but are not limited to, the following: adding an obscuring layer to designated web pages; processing subscription payments from end users; authenticating end users who access the protected web pages to determine their subscription status; and removing the obscuring layer for current subscribers.

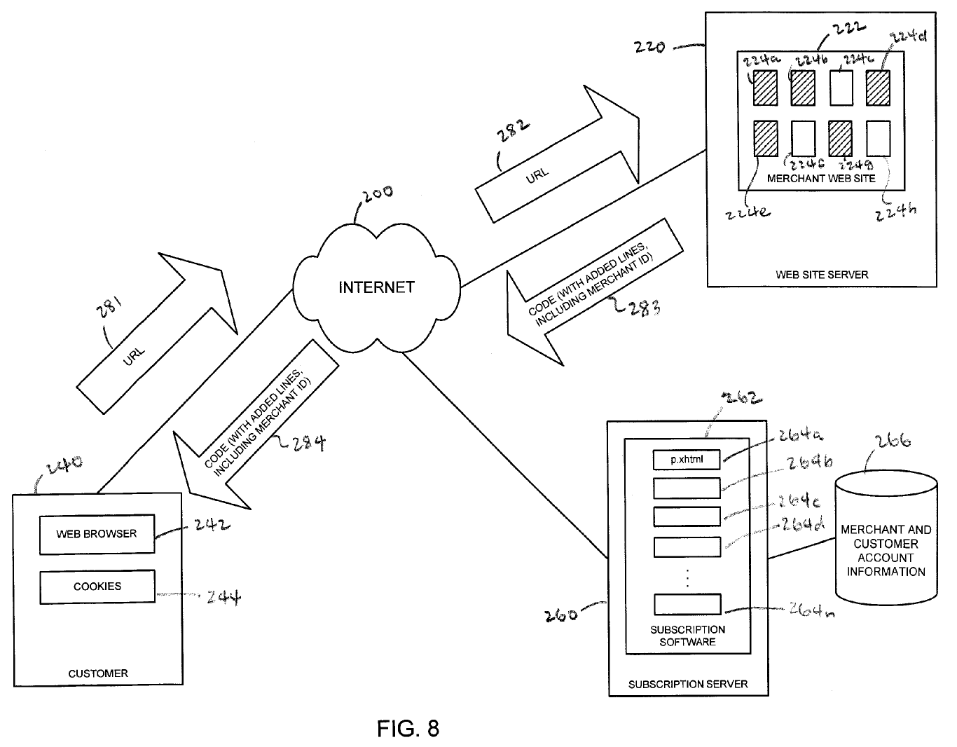

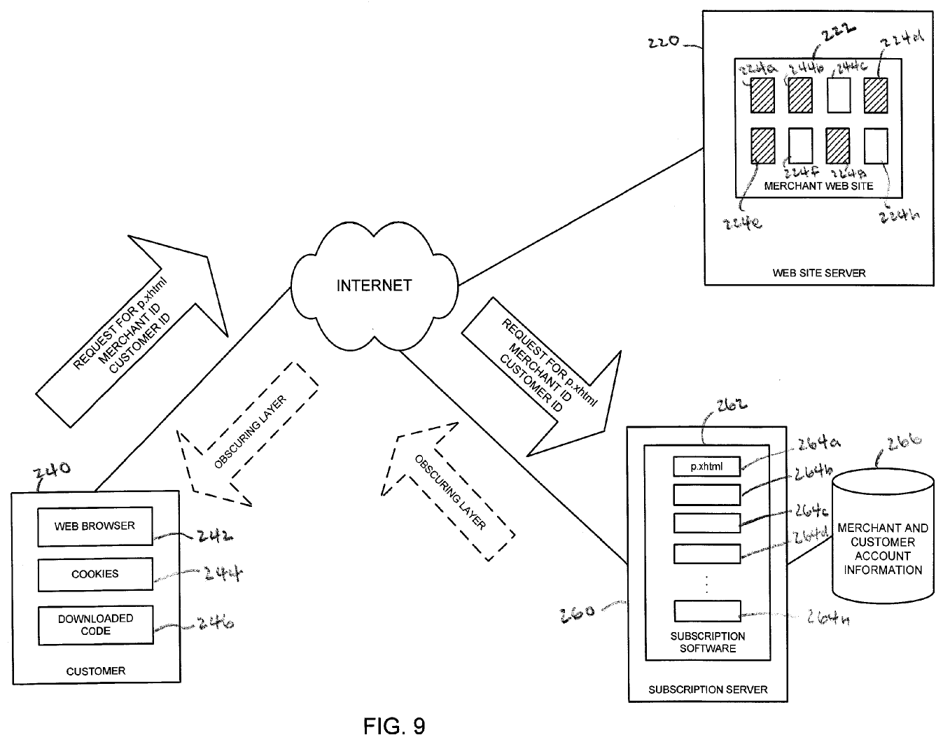

FIGS. 8 and 9 are diagrams illustrating a technique, according to a further aspect of the invention, in which a remote, third-party server is used to perform the subscription functions described above, as well as other functions. In FIGS. 8 and 9, the invention is practiced over the internet 200. However, as mentioned above, the invention may also be practiced over a local network, or in other operating environments.

Connected to the internet 200 are the following: a web site server 220, a customer computer 240, and a subscription server 260. For the purposes of discussion, intermediate computing entities, such as local area networks, firewalls, internet service providers, and the like, have been omitted. However, it will be appreciated that such intermediate and other computing entities are not necessary to an understanding of the present invention. Further, it is not intended to limit the scope of the invention to the particular configuration shown in FIGS. 8 and 9.

A merchant web site 222 is located on the web site server 220. The merchant web site 222 includes web pages 224a-h and associated files. Certain web pages 224a, 224b, 224d, 224e, and 224g have been shaded to indicate that these web pages have been designated by the merchant as “paid content” web pages, to be protected by an obscuring layer. The remaining web pages 224c, 224f, and 224h are unshaded to indicate that they are “free content” web pages, which are not protected by an obscuring layer. As discussed below, a merchant converts a free content web page into a paid content web page by adding a small amount of code to the free content web page. A paid content web page can be converted back into a free content web page by deleting the added code.

As further shown in FIG. 8, the customer computer 240 runs a web browser 242, such as Internet Explorer, Netscape Navigator, or the like. In addition, the customer computer includes cookies 244, which are written to the computer by web sites visited by the customer.

The subscription server 260 runs subscription software 262, which includes a number of modules 264a-n, including script files and associated files. In addition, the subscription server has access to a database 266 containing merchant and customer account information.

As shown by arrows 281 and 282, a customer computer 240 initiates the process by submitting a URL request that is forwarded over the internet 200 to the web site server 220. As shown by arrows 283 and 284, in response to the URL request, the code for the requested page is forwarded back to the customer 240. It is assumed for the purposes of discussion that the customer 240 has requested a protected web page from the merchant web site. The returned code includes code that has been added as described herein. The added code includes a merchant ID, which uniquely identifies the merchant whose web site is being accessed by the customer.

In FIG. 9, the customer computer 240 runs the code 246 downloaded from the merchant web site 222. As shown by arrows 285 and 286, executing the added code causes the customer computer 240 to send to the subscription server a request for an executable file, p.xhtml. This file, which is written in Extensible Hypertext Markup Language, performs certain functions, described below, calling on other software modules 264b-n and the merchant and customer database 266, as needed. A sample p.xhtml file is being submitted as an appendix hereto, in the form of an electronic text file, p.xhtml.txt.

As further shown by arrows 285 and 286, the customer computer also sends to the subscription server the merchant ID that was included with the added code, and a customer ID. As discussed above, the customer ID may take the form of a cookie that has been written to the customer computer 240 when the customer logs onto the subscription server web site. It should be noted that the precise order and timing of the sending of data from the customer computer 240 to the subscription server computer 260 may be modified without departing from the spirit of the invention.

The subscription server 260 running the subscription software 262 uses the merchant ID and the customer ID to perform a lookup operation in database 266 to determine whether the customer has a current subscription to the merchant's web site. If not, then, as shown by arrows 287 and 288, an obscuring layer is sent back to the customer's computer 240 that is displayed in conjunction with the requested web page. However, if it is determined that the customer is a current subscriber, then no obscuring layer is sent, thereby providing the customer with an unobscured view of the requested web page.

It may be seen from FIG. 9 that it would be possible for a customer 240 to defeat the obscuring layer by blocking content from the subscription server 260. Thus, according to a further aspect of the invention, the file p.xhtml includes code that detects whether the requesting computer is blocking content from the subscription server. If content blocking is detected, an error screen is displayed. This aspect of the invention is described in further detail below.

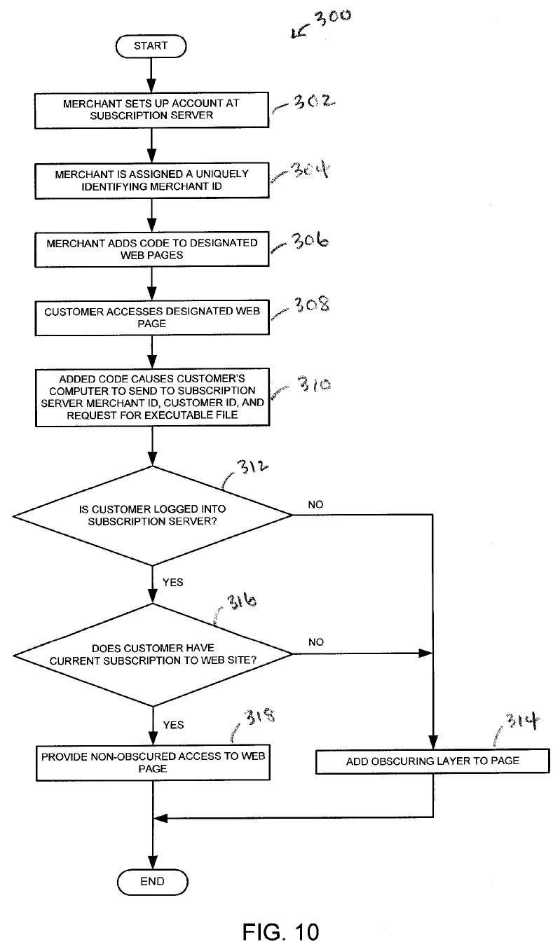

FIG. 10 shows a flowchart of a method 300 embodying the technique illustrated in FIGS. 8 and 9, and described above. In step 302, a merchant sets up an account at the subscription server. As part of the setup process, in step 304, the merchant is assigned a uniquely identifying merchant ID. Further, the merchant is provided with code which, in step 306, is added to each web page containing paid content. The added code includes the merchant ID. In addition, the merchant designates a subscription fee for the web site. According to the present aspect of the invention, a merchant selects a subscription fee ranging from $0.25 to $2.00, in increments of $0.25.

It is common for web sites to include both paid content and free content. According to a further aspect of the invention, a merchant may choose to add the subscription setup code only to certain pages on a web site. The pages not including the added code will continue to be accessible by end users, without an obscuring layer. The merchant can freely change which pages are protected by an obscuring layer, by adding or removing the setup code from individual pages on the web site.

According to a further aspect of the invention, only a minimal amount of code is added to each protected web page. An example of added code is:

<script
src=“https://www.pixelpass.com/p.xhtml?proxyId=dem08658”>
</script>
<noscript><link rel=“stylesheet” type=“text/css”

href=“https://www.pixelpass.com/styles/nojs.css”></noscript>

In the added code, the merchant Proxy ID is dem08658. The first part of the added code causes the end user's computer to download and execute the file “p.xhtml,” which is located at the URL: “www.pixelpass.com/p.xhtml” A sample p.xhtml file is attached as an appendix hereto, in the form of an electronic text file, p.xhtml.txt. The second part of the added code provides for the situation in which an end user is using a web browser that is not configured to run Java or JavaScript. In that case, a blank screen is displayed at the customer's computer.

In step 308, a customer accesses a designated web page. This can be done, for example, by typing the web page URL directly into the address bar of the customer's web browser. Alternatively, the user can use a mouse or other pointing device to click on a hyperlink to the designated web page.

The code from the designated web page is downloaded by the customer's web browser. The downloaded web page includes the added code, which in step 310 causes the end user's computer to request the p.xhtml file from the subscription server. The request includes the merchant ID. In addition, in step 310, a customer ID cookie stored on the end user's computer is sent to the remote server. This cookie can be sent as part of the request for the p.xhtml file, or can be sent separately.

In step 312, a determination is made as to whether the customer is logged into the subscription server. As discussed above, a customer ID cookie is written to the customer's computer when the customer logs onto the subscription server. If the customer is not logged into the subscription server, the customer ID cookie will have a null value, indicating that the customer is not currently logged onto the subscription server.

If it is determined in step 312 that the customer is not logged in, then in step 314, an obscuring layer is added to the designated web page for display on the customer's computer.

If it is determined in step 312 that the customer is logged in, then in step 316, a determination is made as to whether the customer has a current subscription to the web site containing the protected web page being accessed by the customer. This determination can be made, for example, by searching a current subscriber database for a merchant to see whether the identified customer is listed in the database.

If in step 316, it is determined that the customer does not have a current subscription to the web site, then in step 318, an obscuring layer is added to the accessed web page. If the customer has a current subscription to the designated web page, then in step 318, no obscuring layer is added to the designated web page, and the customer is provided with non-obscured access to the web site.

A further aspect of the invention provides for the situation in which the customer's web browser is configured to block content from the subscription server website. In that case, script contained in the p.xhtml file causes the following error message to be displayed at the customer's computer:

This page was not displayed because the PixelPass authentication image was blocked. If you recently turned on an ad blocker, please disable it for pixelpass.com. In Mozilla Firefox, go to Tools→Options . . . . Then, in the Web Features section, click on the Exceptions button next to the Load Images label. Select pixelpass.com in the list and click Remove Site. After you have unblocked PixelPass, reload this page.

When a customer sets up an account at the subscription server, the end user makes an initial deposit into the account. Subscription payments are made by posting a debit to the end user's account and posting a corresponding credit to the merchant's account, less any fees charged by the subscription server.

It will be appreciated that the above—described technique for managing a web site's subscription program has a number of advantages:

The subscription program is easy to set up. Even a relatively unsophisticated content provider is typically able to cut and paste code into designated web pages. In addition, a content provider does not have to maintain a list of subscribers. Rather the subscriber list is maintained on the subscription server. Also, because the subscription server is paid out of subscription proceeds, no initial payment is required from the merchant.

Further, a merchant does not have to process payments from, or refunds to, subscribers. Rather, payments are made by debiting and crediting customer and merchant accounts at the subscription server. The subscription server can then pay out subscription proceeds to the merchant in a number of ways. For example, it would be possible to the subscription server to pay out funds to the merchant in the form of a check when the merchant's account exceeds a certain minimum.

A content provider is able to easily change the protection status of individual pages at a web site. Thus, a merchant can experiment with offering different amounts of free content. Also, a content provider is able to easily change the subscription fee by updating the merchant's account profile at the subscription server.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

What is claimed is:

1. A method for managing subscriptions to a web site, comprising:
(a) determining whether an end user accessing a designated web page at the web site has a current subscription to the web site;
(b) if it is determined that the end user does not have a current subscription to the web site, placing an obscuring layer over the designated web page that at least partially obscures at least a portion of the web page, the obscuring layer including a link to a subscription server for purchasing a subscription to the designated web page; and
(c) if it is determined that the end user has a current subscription to the web site, providing the end user with an unobscured view of the designated web page.

2. The method of claim 1, wherein in step (b), a substantial portion of the web page is viewable through and around the obscuring layer.

3. The method of claim 2, wherein at least a portion of the obscuring layer includes a matrix of shapes that are closely spaced in a grid, such that portions of the web page are viewable between adjacent shapes in the grid.

4. The method of claim 3, wherein the shapes in the grid are squares that arranged such that the spaces between the squares in the grid define a plurality of intersecting horizontal and vertical lines, through which the designated web page is viewable.

5. The method of claim 2, wherein the obscuring layer further includes an opaque box for displaying information to an end user.

6. The method of claim 1, wherein the obscuring layer comprises a bar extending vertically through the designated web page.

7. The method of claim 1, wherein an end user may connect to the subscription server by clicking anywhere on the obscuring layer.

8. The method of claim 1, further including:
incorporating a time component into the obscuring layer, whereby the obscuring layer changes in appearance as a function of time.

9. A method for managing subscriptions to a web site, comprising:
(a) accessing a remote subscription server when an end user accesses a designated web page at the web site;
(b) sending to the remote subscription server an end user identification and a merchant identification;
(c) determining, at the remote subscription server, whether the end user has a current subscription to view the web page;
(d) if it is determined that the end user does not have a current subscription to view the web page, sending from the remote server to the end user an obscuring layer that at least partially obscures at least a portion of the web page.

10. The method of claim 9, wherein in step (b), the end user identification includes an indication as to whether the end user is currently logged into the subscription server.

11. The method of claim 10, wherein the end user identification comprises a cookie that is written to the end user's computer when the end user is logged onto the remote subscription server.

12. The method of claim 9, further including:
incorporating a time component into the obscuring layer, whereby the obscuring layer changes in appearance as a function of time.

13. A method for managing subscriptions to a web site, comprising:
(a) adding code to a designated web page at the web site that, when an end user accesses the designated web page, causes the end user to access a remote subscription server to request a script file, the request including an end user identification and a merchant identification;
(b) executing the script file to determine whether the end user has a current subscription to the web site;
(c) if it is determined that the end user does not have a current subscription to view the web page, adding an obscuring layer to the designated web page that at least partially obscures at least a portion of the designated web page.

14. The method of claim 13, wherein in step (a), the end user identification includes an indication as to whether the end user is currently logged into the subscription server.

15. The method of claim 14, wherein the end user identification comprises a cookie that is written to the end user's computer when the end user is logged onto the remote subscription server.

16. The method of claim 13, further including:
executing the script file to determine whether the end user is blocking content from the subscription server; and
if it is determined that the end user is blocking content from the subscription server, displaying an error screen to the end user.

17. The method of claim 13, further including:
executing the added code to determine whether the end user is configured to run Java and JavaScript; and
if is determined that the end user is not configured to run Java and JavaScript, displaying a blank screen to the end user.

18. The method of claim 14, further including:
incorporating a time component into the obscuring layer, whereby the obscuring layer changes in appearance as a function of time.
